(19) United States
(12) Patent Application Publication
(10) Pub. No.: US 2017/0258173 A1
(43) Pub. Date: Sep. 14, 2017

(54) Running Shoe Wear Indicator

(71) Applicant: Summer E. Johnson, Plymouth, MN (US)

(72) Inventor: Summer E. Johnson, Plymouth, MN (US)

(21) Appl. No.: 15/456,282

(22) Filed: Mar. 10, 2017

Related U.S. Application Data
(60) Provisional application No. 62/306,276, filed on Mar. 10, 2016.

(51) Int. Cl. A43B 3/00; G08B 5/36; A43B 23/02; G06F 3/147; A43B 13/12

(52) U.S. Cl. CPC A43B 3/0005; G06F 3/147; A43B 13/122; A43B 13/125; A43B 23/0245; G08B 5/36

(57) ABSTRACT

An integrated circuit for measuring and indicating wear on an athletic shoe. The circuit features a display located on the sole of the shoe to give a clear visual indication of remaining life of the shoe.

### CROSS REFERENCE TO RELATED APPLICATION

This application claims priority to the U.S. Provisional Application No. 62/306,276, to Summer Johnson, entitled “Running Shoe Wear Indicator,” filed Mar. 10, 2016, which is hereby incorporated by reference in its entirety.

### FIELD OF THE DISCLOSURE

The present disclosure relates to a system for determining shoe life that calculates the remaining life of the shoe and a display that indicates the remaining life to the user.

### BACKGROUND OF THE DISCLOSURE

The running shoes/athletics market is massive. Many individuals overuse their shoes/footwear to their possible health detriment. Shoe overuse is linked to many physical health conditions from foot/ankle issues to knee problems. Athletes and the senior population are at especially greater risk of these possible issues. Those that are aware of the dangers of overuse have identified ways to check their shoes' conditions such as a visual inspection or bending their shoes, but these “home remedies” are often not very accurate. A visual indication of shoe wear so that consumers know when it is time to retire old shoes and purchase a new shoes can be useful to help combat this problem. Consumers will not only be more willing to buy shoes with this feature, they will be more likely to avoid the associated health problems.

### SUMMARY OF THE DISCLOSURE

The present disclosure relates to an electronic circuit built into the sole of a shoe featuring an electronic display.

According to the present disclosure, a system for determining footwear life is provided. The system includes a sensor, an embedded circuit, a display, and a power-source. The sensor detects the stride of the footwear user. The embedded circuit collects and processes the data from the sensor to determine remaining life of the footwear. The display electronically couples to the embedded circuit and illustrates the remaining life of the footwear. The display area of the display has a first portion and a second portion with different visual contrast from the first portion. The display ratio of the first portion to the second portion is proportional to the determined about of remaining life of the footwear. The power source of the system is electrically coupled to the embedded circuit.

According to the present disclosure, footwear that includes a footwear life system. The footwear includes a sole, an upper supported by the sole, and a footwear life system. The footwear life system includes a sensor, an embedded circuit, a display, and a power-source. The sensor detects the stride of the footwear user. The embedded circuit collects and processes the data from the sensor to determine remaining life of the footwear. The display electronically couples to the embedded circuit and illustrates the remaining life of the footwear. The display area of the display has a first portion, and a second portion with different visual contrast from the first portion. The display ratio of the first portion to the second portion is proportional to the determined about of remaining life of the footwear. The power source of the system is electrically coupled to the embedded circuit.

### BRIEF DESCRIPTION OF THE DRAWINGS

The aforementioned aspects and many of the intended advantages of this disclosure will grow to be appreciated at a greater level once references to the following accompanying illustrations are expounded upon.

FIG. 1 is a perspective view of shoe with a display visible on the outsole;

FIG. 2 depicts a first embodiment of an integrated circuit;

FIG. 3 depicts a second embodiment of an integrated circuit;

FIG. 4 depicts a circuit in a bracket-shaped housing coupled to the upper of a shoe; and

FIG. 5 depicts a bracket-shaped housing of FIG. 4 that couples the circuit to the upper of the shoe.

Equivalent reference components point to corresponding parts throughout the several views. Even though the drawings depict manifestations of components and attributes to the present disclosure, certain features are magnified due to the fact that not only are the drawings are not scalable, but also because this method is the best way to illustrate the present disclosure. Wherein, the illustrations depicted are manifestations of the disclosure, and such illustrations shall in no way be interpreted as limiting the scope of the disclosure.

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

### DETAILED DESCRIPTION OF THE DRAWINGS

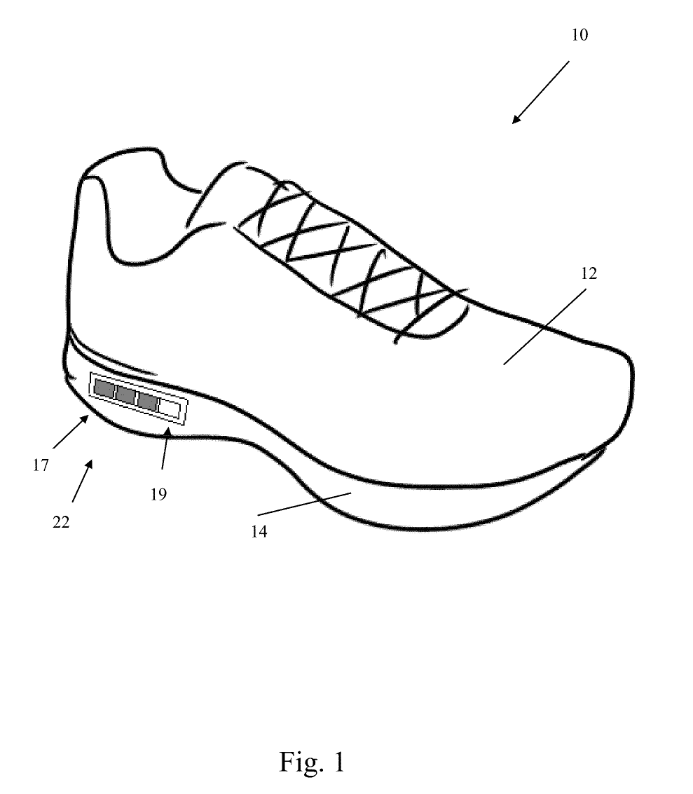

Referring to FIG. 1, a shoe 10 is shown. Shoe 10 includes an upper 12 and a sole 14. In a primary embodiment, a circuit 20 featuring a bar-shaped display 22 is placed in sole 14 of shoe 10. Display 16 is preferably an electronic ink display. Display 22 shows the remaining life of shoe 10 analogous to a fuel gauge; as shoe 10 is continuously used, less of display 22 is lit. In an alternative embodiment, as shoe 10 is continuously used, more of the display 22 is lit.

As shown in FIG. 1, a first portion 17 of display 22 is darker than a second portion 19 of display 22. First portion 17 consist of three dark segments and second portion 19 consists of one light segment. When shoe 10 was new, no segments of display 22 were dark and all segments were lit indicating that all or substantially all of shoe's useful life remained. As shown in FIG. 1, only about 25% of the useful life remains because only 25% of display is lit. Thus, as the number of steps/strides/impacts detected by circuit 20 increases, the amount of display 22 that is lit decreases and the ratio of the portion of display 22 that is dark to the ratio of the portion of display 22 that is light changes. As shown in FIG. 1, first portion 17 has a darker contrast than second portion 19. According to alternative embodiments, other differences in contrast may be provided, such as color.

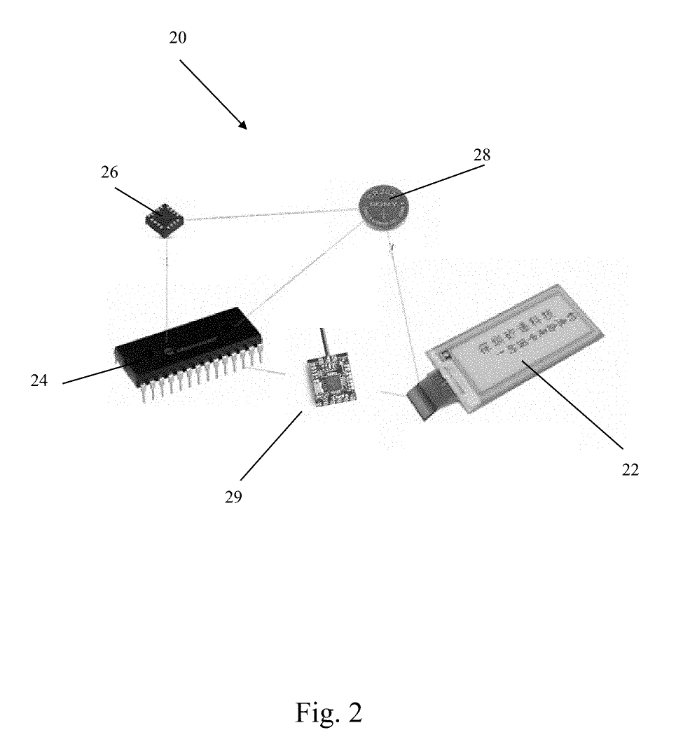

Referring to FIG. 2, one embodiment of an embedded circuit 20 is shown. Circuit 20 is placed within sole 14 of shoe 10 and includes display 22, such as an electronic ink or OLED display, an embedded circuit 24, such as an ARM-brand processor, for step counting and display outputting, a 3D accelerometer 26, and a battery 28. Battery 28 powers accelerometer 26, integrated circuit 24, and display 22. Accelerometer 26 relays data to the integrated circuit 24. As the shoe is used, circuit 24 estimates the number of feet per stride to determine the remaining life of shoe 10. Accelerometer 26 detects a step/stride by sensing impacts of shoe 10. According to one embodiment of the present disclosure, circuit 24 counts the number of detected impacts and changes the ratio of the amount display 22 that is dark to the amount of display 22 that is lit based on the number of recommended steps/slides/impacts remaining in the useful life of shoe 10. For example, if the useful life of shoe 10 is 400,000 steps/strides/impacts (i.e. 400 miles @ 1,000 steps per mile per shoe), circuit 24 will count the number of detected impacts and compare it to 400,000. For the embodiment of FIG. 1, one of the segments will go dark at about 100,000 impacts (indicating 25% of the useful life is used), two will go dark at about 200,000 impacts, three will go dark at 300,000 impacts, and all of the segments will go dark at 400,000 impacts. As shown in FIG. 1, display 22 is shown in four segments. According to alternative embodiments, display 22 may have fewer or more segments or be more finite.

As shown in FIG. 2, circuit 24 includes a transmitter 29 that communicates with a wireless device, such as a smart phone (not shown). Circuit 24 communicates the remaining life, steps, etc. to the wireless device for useful life, distance, and other tracking purposes. The smartphone may use the date to provide notifications and prompts to purchase new shoes as the end of the useful life of shoe 10 is approaching.

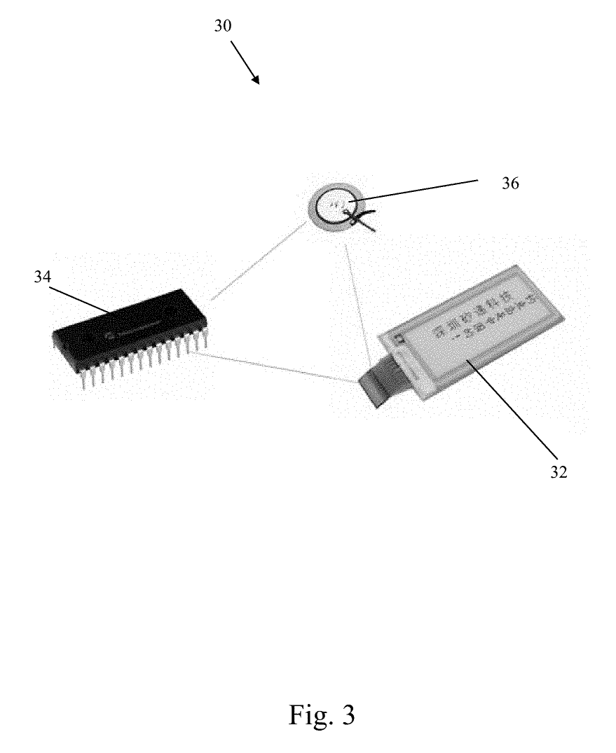

Referring to FIG. 3, an alternate embodiment of an embedded circuit 30 is shown. Circuit 30 may also be placed within sole 14 of shoe 10. Circuit 30 includes an electronic ink display 22, an embedded circuit 34, and a piezoelectric motor 36. Rather than rely on a battery for power as with circuit 20, as a user generates steps with shoe 10, piezo electric motor 36 sends power to integrated circuit 34 and display 22.

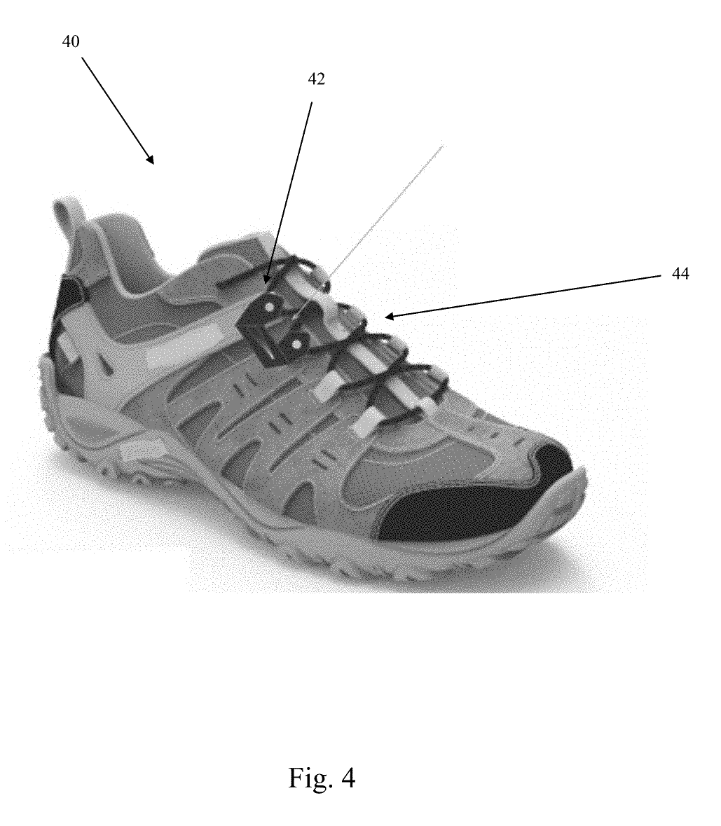

Referring to FIG. 4, a method for coupling circuit 30 to a shoe 40 is shown. Circuit 30 may be placed in housing 42 for attachment to laces 44 of shoe 40. By untying laces 44, circuit 30 can be removed, reset, and placed on a new pair of shoes.

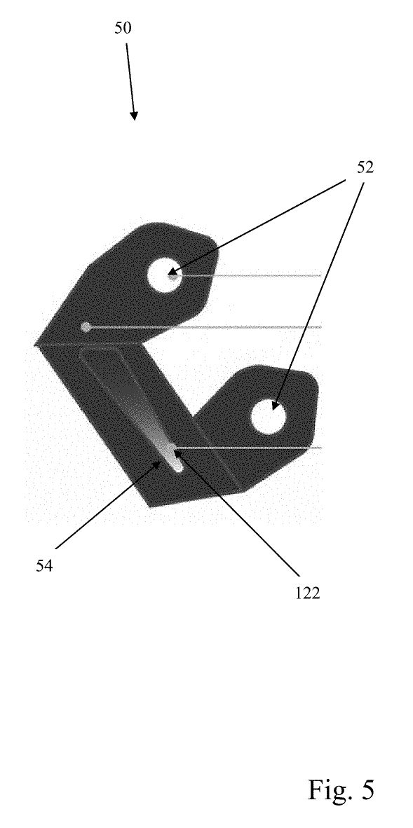

Referring to FIG. 5, a bracket-shaped housing 50 is shown. Laces 44 of shoe 40 extend through holes 52 of bracket-shaped housing 50. Display 122 faces screen reveal cutout 54. Cutout 54 exposes 122 display to indicate the remaining shoe life. As shown in FIG. 5, display 122 has a more gradual indication of useable life than display 22. Rather than four segments, display 122 shows a gradient that indicates the remaining useful life of about 30%. Similar to display 22, display 122 changes the ratio of the dark to light portions as circuit 30 detects steps/strides/impacts. When display 122 is completely dark, a user knows that the useful life of shoe 44 is up.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

I claim:

1. A system for determining shoe life including
a sensor to detect a stride of a shoe user,
an embedded circuit to collect and process data from the sensor to determine remaining life of the shoe,
a display electronically coupled to the embedded circuit, the display area illustrating the remaining life of the shoe, the display area having a first portion and a second portion having a different visual contrast from the first portion, a ratio of the first portion to second portions being proportionally to the determined about of remaining life of the shoe, and
a power-source electrically coupled to the embedded circuit.

2. The system of claim 1, where the sensor includes an accelerometer.

3. The system of claim 1, where the sensor includes a gyroscope.

4. The system of claim 1, where the display is bar-shaped.

5. The system of claim 1, where the display is electronic paper defining the display area.

6. The system of claim 1, where the display is an E-ink display defining the display area.

7. The system of claim 1, where the display is an OLED display defining the display area.

8. The system of claim 1, where the power-source is a battery.

9. The system of claim 1, where the power-source is a piezoelectric motor.

10. Shoe having a shoe life system, the shoe including
a sole,
an upper supported by the sole, and
a shoe life system supported by the sole including
a sensor to detect a stride of a shoe user,
an embedded circuit, to collect and process data from the sensor to determine remaining life of the shoe,
a display electronically coupled to the embedded circuit, the display area illustrating the remaining life of the shoe, the display area having a first portion and a second portion having a different visual contrast from the first portion, a ratio of the first portion to second portions being proportionally to the determined about of remaining life of the shoe, and
a power-source electrically coupled to the embedded circuit.

11. The shoe of claim 10, wherein the shoe life system is embedded in the sole.

12. The shoe of claim 11, wherein the shoe life system is embedded in a midsole of the shoe.

13. The shoe of claim 11, wherein the shoe life system is embedded in the outsole of the shoe.

14. The shoe of claim 10, wherein the shoe life system is coupled to the upper.

15. The shoe of claim 14, wherein the shoe life system includes a housing removably coupled to the upper.

16. The shoe of claim 14, wherein the housing is bracket-shaped.

17. The shoe of claim 16, wherein the housing includes holes and the upper includes laces extending through the holes.
